(19) United States
(12) Patent Application Publication
(10) Pub. No.: US 2007/0280186 A1
(43) Pub. Date: Dec. 6, 2007

(54) Information processing apparatus and access control method

(76) Inventor: Taizo Kaneko, Hidaka-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/787,697

(22) Filed: Apr. 17, 2007

(30) Foreign Application Priority Data
May 31, 2006 (JP) 2006-151672

(51) Int. Cl. H04Q 7/24

(52) U.S. Cl. 370/338

(57) ABSTRACT

According to one embodiment, an information processing apparatus includes a wireless communication unit, a storage device which stores predetermined data, a detection unit which detects base stations which are wirelessly connectable to the wireless communication unit, and an access control unit. The access control unit determines whether or not to permit access to the predetermined data, in accordance with a combination of the base stations which are detected by the detection unit.

### CROSS-REFERENCE TO RELATED APPLICATIONS

This application is based upon and claims the benefit of priority from Japanese Patent Application No. 2006-151672, filed May 31, 2006, the entire contents of which are incorporated herein by reference.

### BACKGROUND

1. Field

One embodiment of the invention relates to an information processing apparatus such as a personal computer, which has, for example, a wireless communication function, and to an access control method for use in the apparatus.

2. Description of the Related Art

In recent years, various portable personal computers of a laptop type or a notebook type have been developed. Most of these types of computer have wireless communication functions according to a wireless communication standard such as Wireless LAN.

Jpn. Pat. Appln. KOKAI Publication No. 2004-185531 discloses a data communication terminal having a wireless communication function. As regards this data communication terminal, when a user having the data communication terminal has entered a Wireless LAN service area, access to a data storage unit within the data communication terminal is automatically prohibited. Thereby, the data in the data storage unit is prevented from leaking to the outside via the Wireless LAN.

In the meantime, recently, there has been an increasing amount of information which requires protection, such as personal information or confidential company information. Thus, in companies, work involving confidential information is done only in a specified secure area, which is established, for example, in a part of the office.

If a computer which stores, e.g., confidential company information is used outside the specified area, the possibility of the confidential information leaking to the outside increases.

It is thus necessary to realize a novel function of permitting the use of data, such as confidential information, which is stored in the computer, only when the place where the computer is used is within the secure area.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view for describing the relationship between an information processing apparatus according to an embodiment of the invention and a wireless network system;

FIG. 2 is an exemplary block diagram showing an example of the structure of the information processing apparatus shown in FIG. 1;

FIG. 3 is an exemplary flowchart illustrating the procedure of an access control process which is executed by the information processing apparatus shown in FIG. 1;

FIG. 4 shows a first example of the software configuration of the information processing apparatus shown in FIG. 1;

FIG. 5 shows a second example of the software configuration of the information processing apparatus shown in FIG. 1;

FIG. 6 is an exemplary block diagram showing the system configuration of the information processing apparatus shown in FIG. 1;

FIG. 7 illustrates an example of an access control corresponding to a case where the information processing apparatus shown in FIG. 1 has detected only one specified access point;

FIG. 8 illustrates an example of an access control corresponding to a case where the information processing apparatus shown in FIG. 1 has detected two specified access points;

FIG. 9 illustrates an example of an access control corresponding to a case where the information processing apparatus shown in FIG. 1 has detected three specified access points;

FIG. 10 is an exemplary view for explaining an example of access restriction information which is used in the information processing apparatus shown in FIG. 1;

FIG. 11 is an exemplary view for explaining an example of access right level information which is used in the information processing apparatus shown in FIG. 1;

FIG. 12 is an exemplary flowchart illustrating an example of the specific procedure of the access control process which is executed by the information processing apparatus shown in FIG. 1;

FIG. 13 is an exemplary flowchart illustrating an example of the procedure of an access right level determination process which is executed by the information processing apparatus shown in FIG. 1;

FIG. 14 shows an example of a network system in which the information processing apparatus shown in FIG. 1 is used as a client;

FIG. 15 is an exemplary block diagram for describing another structure of the information processing apparatus shown in FIG. 1;

FIG. 16 is an exemplary block diagram showing the structure of an authentication server which is provided in the network system shown in FIG. 14;

FIG. 17 is an exemplary view for explaining an example of the access right level which is set for data in a data server which is provided in the network system shown in FIG. 14;

FIG. 18 is an exemplary view for explaining an example of access restriction information which is used by the authentication server provided in the network system shown in FIG. 14;

FIG. 19 is an exemplary view for explaining an example of the access right level information which is used by the authentication server provided in the network system shown in FIG. 14; and

FIG. 20 is an exemplary flowchart illustrating the procedure of a process which is executed by the authentication server provided in the network system shown in FIG. 14.

### DETAILED DESCRIPTION

Various embodiments according to the invention will be described hereinafter with reference to the accompanying drawings. In general, according to one embodiment of the invention, an information processing apparatus includes a wireless communication unit, a storage device which stores predetermined data, a detection unit which detects base stations which are wirelessly connectable to the wireless communication unit, and an access control unit. The access control unit determines whether or not to permit access to the predetermined data, in accordance with a combination of the base stations which are detected by the detection unit.

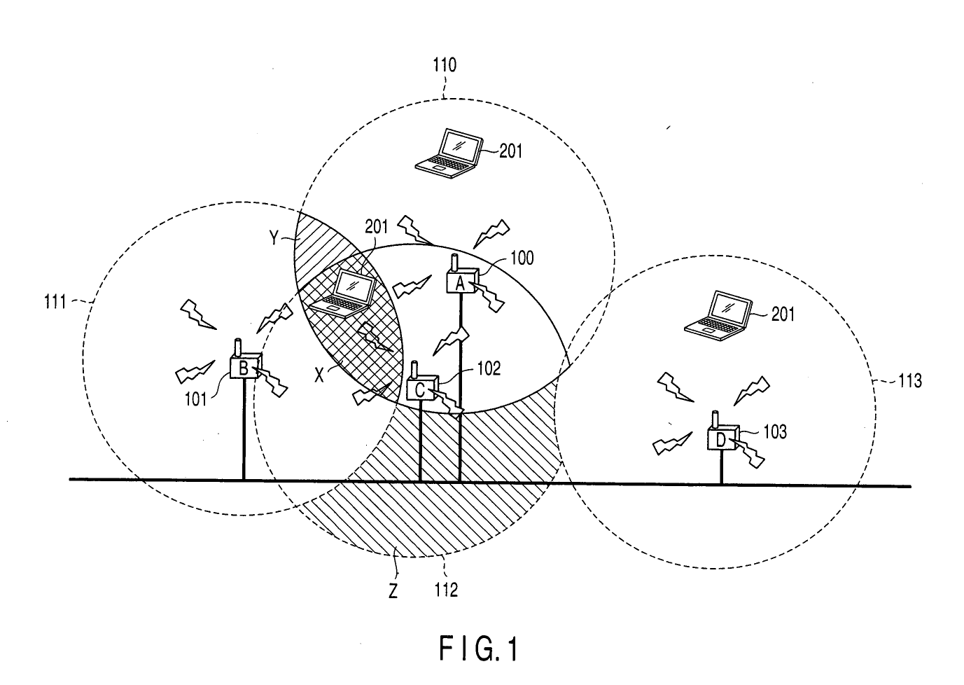

To begin with, referring to FIG. 1, a description is given of the relationship between an information processing apparatus according to the embodiment of the invention and a wireless network system. The information processing apparatus is realized as a battery-powerable notebook portable personal computer 201.

The computer 201 includes a wireless communication unit which executes wireless communication according to a wireless communication standard such as Wireless LAN. With use of the wireless communication unit, the computer 201 functions as a mobile station which is connectable to a wireless network. The computer 201 has an access control function of determining whether the computer 201 is present within a predetermined specified area, and permitting access to specified data, such as, confidential data, which is stored in a local disk in the computer 201, only when it is determined that the computer 201 is present in the specified area. Whether the computer 201 is present in the specified area is determined on the basis of a combination of base stations to which the computer 201 is wirelessly connectable.

For example, in a factory site of a company, a plurality of base stations (hereinafter referred to as “access points”) 100, 101, 102 and 103, which support a wireless communication standard such as Wireless LAN, are disposed in a distributed fashion. The range of each of communication areas 110, 111, 112 and 113, which are covered, respectively, by access point A 100, access point B 101, access point C 102 and access point D 103, is about 50 to 100 m in radius. Each of these communication areas has a range defined by the reach of the radio signals transmitted from the associated access point. Each of the communication areas has a substantially circular shape centered on the associated access point.

In the factory site, a specific secure area is established. The office of the department that handles confidential information is provided in the specified area. This office is composed of a safe building with a high level of security. For example, the positions of the three access points 100, 101 and 102 are determined in advance such that an area X (double-hatched part), in which the three communication areas 110, 111 and 112 overlap, corresponds to the specified area. The shape and range of the area X can be determined by properly arranging the positions of the three access points 100, 101 and 102. If the number of access points to be combined is increased, the shape and range of the area X can be made closer to the shape and range of the specified area.

If the computer 201 is present within the area X, the combination of access points, to which the computer 201 is wirelessly connectable, comprises the access points 100, 101 and 102. If the computer 201 is present, for example, within an area Y (single-hatched part) in FIG. 1, the combination of access points, to which the computer 201 is wirelessly connectable, comprises the access points 100 and 101. If the computer 201 is present, for example, within an area Z (single-hatched part) in FIG. 1, the access point, to which the computer 201 is wirelessly connectable, is only the access point 102.

The computer 201 can thus determine whether the computer 201 is present within the specified secure area (area X) by detecting all access points to which the computer 201 is wirelessly connectable and checking the combination of the detected access points.

In the case where the computer 201 is present within the area X, that is, in the case where the computer 201 is present at a position where the computer 201 can access all the three access points 100, 101 and 102, access is permitted to specified confidential data stored in a data storage device within the computer 201. On the other hand, if the computer 201 is present outside the area X, for example, if the computer 201 is present within the area Y or area Z in FIG. 1, access to the specified confidential data is prohibited.

By the above-described access control, the place where access is permitted to the specified confidential data in the computer 201 can be limited to the inside of the safe area (area X) in the factory site, and the information which requires protection can be prevented from leaking to the outside.

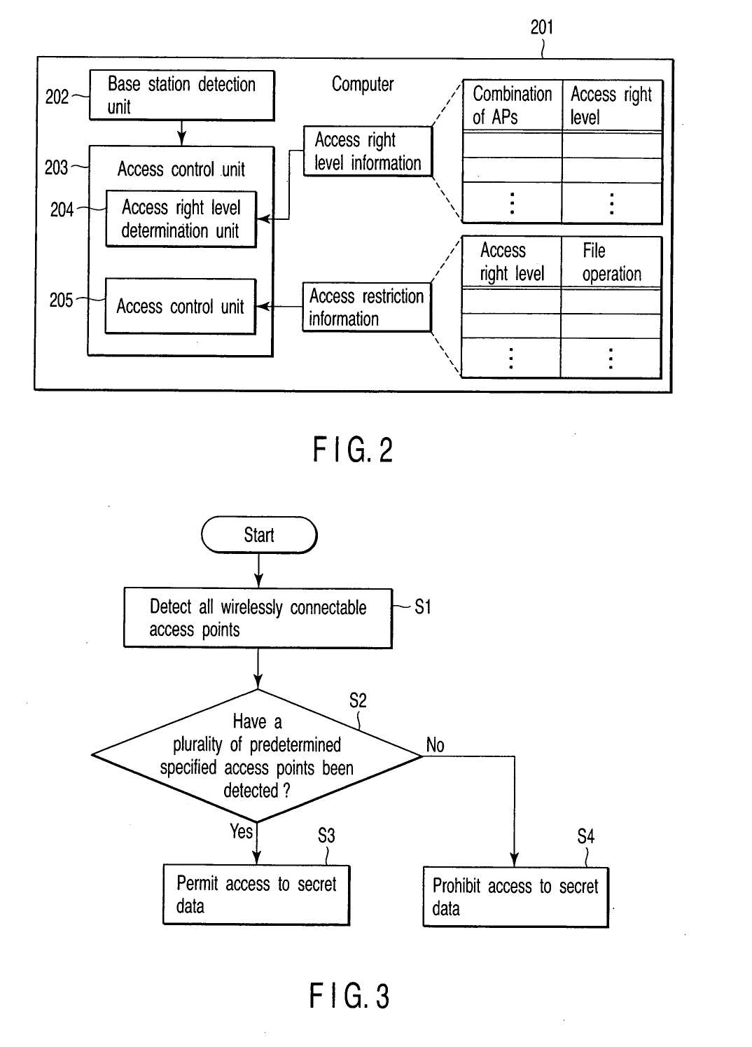

FIG. 2 shows an example of the structure of the computer 201 for realizing the above-described access control function.

The computer 201 includes a base state detection unit 202 and an access control unit 203.

The base station detection unit 202 executes an access point search process for detecting all access points which are wirelessly connectable to the wireless communication unit in the computer 201. The access point search process is executed, for example, in response to power-on of the computer 201 or in response to boot-up of the operating system. In the access point search process, an ID (e.g., access point name, MAC address, etc.), which identifies each access point that is wirelessly connectable to the wireless communication unit, is detected.

The access control unit 203 determines whether access to predetermined data, such as confidential data, is to be permitted or not, on the basis of a combination of access points which have been detected by the access point search process. Specifically, in the case where all of a plurality of predetermined specified access points have been detected by the access point search process, for example, in the case where all of the three access points 100, 101 and 102 have been detected, the access to predetermined data, such as confidential data, is permitted. On the other hand, in the case where at least one of a plurality of predetermined specified access points has not been detected, for example, in the case where only the access point 100 of the three access points 100, 101 and 102 has been detected, the access control unit 203 prohibits the access to predetermined data.

The access control unit 203 may be composed of, for example, an access right level determination unit 204 and an access restriction unit 205.

The access right level determination unit 204 determines the access right level corresponding to the combination of the access points detected by the access point search process, on the basis of access right level information which is prestored in a memory unit in the computer 201.

The access right level information is information which specifies the relationship between combinations of access points AP, on the one hand, and access right levels, on the other hand. In the access right level information, for example, the access right level corresponding to the combination of three access points, i.e., access point A 100, access point B 101 and access point C 102, is set at level 1. The access right level corresponding to the combination of two access points, i.e., access point A 100 and access point B 101, is set at level 2. The access right level corresponding to one of the access point A 100, access point B 101 and access point C 102, is set at level 3.

The access restriction unit 205 determines whether access to predetermined data, such as confidential data, is to be permitted or not, in accordance with the access right level that is determined by the access right level determination unit 204. The access restriction unit 205 lowers the access restriction level as the value of the determined access right level becomes smaller.

In the meantime, the kind of a file operation which is executable on predetermined data may be restricted in accordance with the determined access right level.

In this case, the access restriction unit 205 restricts the kind of a file operation (read access, right access, copy, move, etc.) which is executable on predetermined data such as confidential data, on the basis of the access right level determined by the access right level determination unit 204 and access restriction information which is prestored in the memory unit in the computer 201. The access restriction information is information which specifies the relationship between a plurality of access right levels, on the one hand, and the kinds of file operations to be restricted, on the other hand. For example, if the access right level is level 1, the kind of file operation that is executable on predetermined data is not restricted. If the access right level is level 2, write access to predetermined data is prohibited. If the access right level is level 3, any of the file operations on predetermined data is prohibited. Needless to say, the relationship between the access right levels and the file operations to be restricted is not limited to this example.

Next, referring to a flowchart of FIG. 3, the procedure of the access control process, which is executed by the computer 201, is described.

Assume now that access to predetermined confidential data is permitted only in the case where the computer 201 is present within the area X and access to predetermined confidential data is prohibited in the case where the computer 201 is present outside the area X.

To start with, the base station detection unit 202 executes the access point search process by controlling the wireless communication unit in the computer 201, thereby detecting all access points which are wirelessly connectable to the wireless communication unit (block S1).

The access control unit 203 determines whether all of a plurality of predetermined specified access points, that is, all of the access point A 100, access point B 101 and access point C 102, have been detected by the base station detection unit 202 (block S2).

If all of the access point A 100, access point B 101 and access point C 102 have been detected by the base station detection unit 202 (YES in block S2), the access control unit 203 determines that the computer 201 is present within the area X and permits access to predetermined confidential data (secret data) (block S3).

On the other hand, if at least one of the access point A 100, access point B 101 and access point C 102 has not been detected by the base station detection unit 202 (NO in block S2), the access control unit 203 determines that the computer 201 is present outside the area X and prohibits access to predetermined confidential data (block S4).

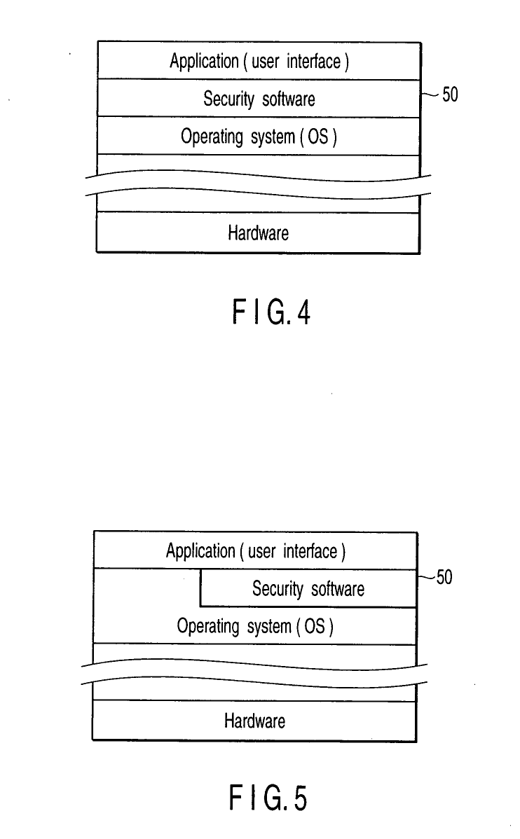

Next, referring to FIG. 4 and FIG. 5, examples of the software structure of the computer 201 are described.

FIG. 4 shows an example of the software structure in a case where the above-described access control function is executed by dedicated software which is independent from the operating system. The functions of the base station detection unit 202 and access control unit 203 are executed by security software 50 which is dedicated software that is independent from the operating system. The security software 50 can set, in association with each data (file, folder, etc.) stored in the local disk in the computer 201, an access right level which is necessary for accessing the data. The security software 50 executes an access control for access to each data stored in the local disk, in accordance with the combination of access points which are detected by the access point search process.

FIG. 5 shows an example of the software structure in a case where the above-described access control function is executed by the operating system. The functions of the base station detection unit 202 and access control unit 203 are executed by security software 50 which is built in the operating system.

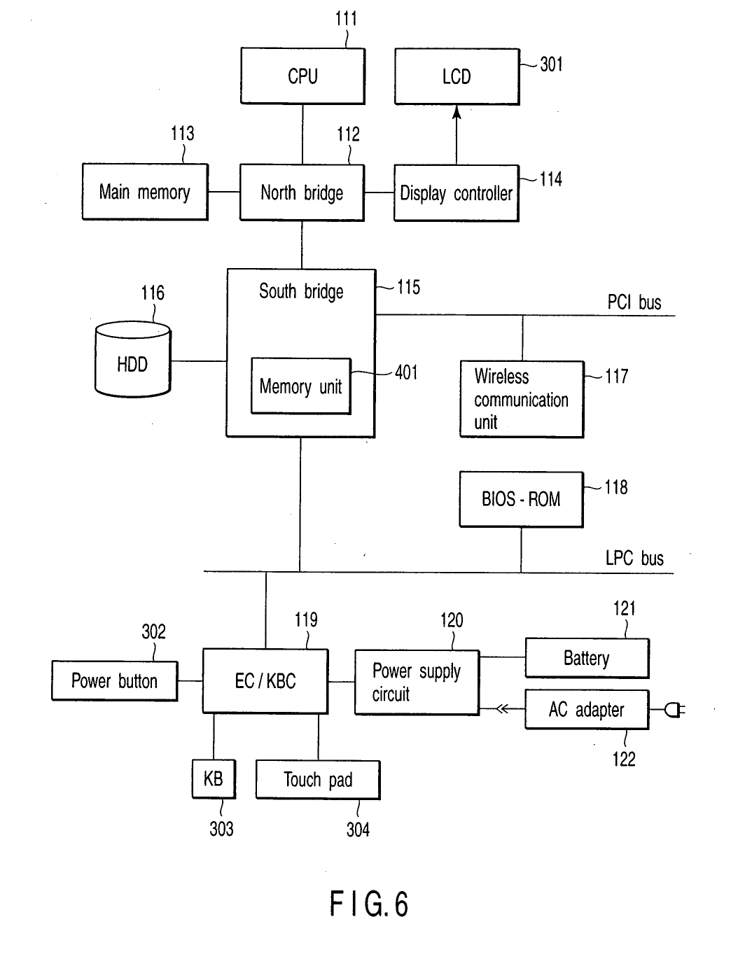

FIG. 6 shows the system configuration of the computer 201.

The computer 201 comprises a computer main body and a display unit which is attached to the computer main body. The computer main body includes a CPU 111, a north bridge 112, a main memory 113, a display controller 114, a south bridge 115, a hard disk drive (HDD) 116, a wireless communication unit 117, a flash BIOS-ROM 118, an embedded controller/keyboard controller IC (EC/KBC) 119, and a power supply circuit 120.

The CPU 111 is a processor that controls the operation of the components of the computer 201. The CPU 111 executes an operating system and various application programs/utility programs, which are loaded from the HDD (local disk) 116 into the main memory 113. The CPU 111 also executes a Basic Input/Output System (BIOS) that is stored in the flash BIOS-ROM 118. The BIOS is a program for hardware control.

The north bridge 112 is a bridge device that connects a local bus of the CPU 111 and the south bridge 115. In addition, the north bridge 112 has a function of executing communication with the display controller 114 via, e.g., an Accelerated Graphics Port (AGP) bus. Further, the north bridge 112 includes a memory controller that controls the main memory 113.

The display controller 114 controls an LCD 301 which is used as a display device of the computer 201. The south bridge 115 is connected to a Peripheral Component Interconnect (PCI) bus and a Low Pin Count (LPC) bus.

The south bridge 115 incorporates a memory unit 401 which is composed of, e.g., a nonvolatile memory. The memory unit 401 prestores the above-described access right level information and access restriction information.

The wireless communication unit 117 is a wireless network device which executes wireless communication according to the IEEE 801.11 standard. The embedded controller/keyboard controller IC (EC/KBC) 119 is a single-chip microcomputer in which an embedded controller for power management and a keyboard controller for controlling a keyboard (KB) 303 and a touch pad (mouse) 304 are integrated. The keyboard (KB) 303 and touch pad (mouse) 304 are input devices and are provided, for example, on the top surface of the computer main body.

The embedded controller/keyboard controller IC 119 cooperates with the power supply circuit 120 to power on/off the computer 201 in response to the user's operation of a power button switch 302. The power supply circuit 120 generates system power, which is to be supplied to the components of the computer 201, using power from a battery 121 or external power supplied from an AC adapter 122.

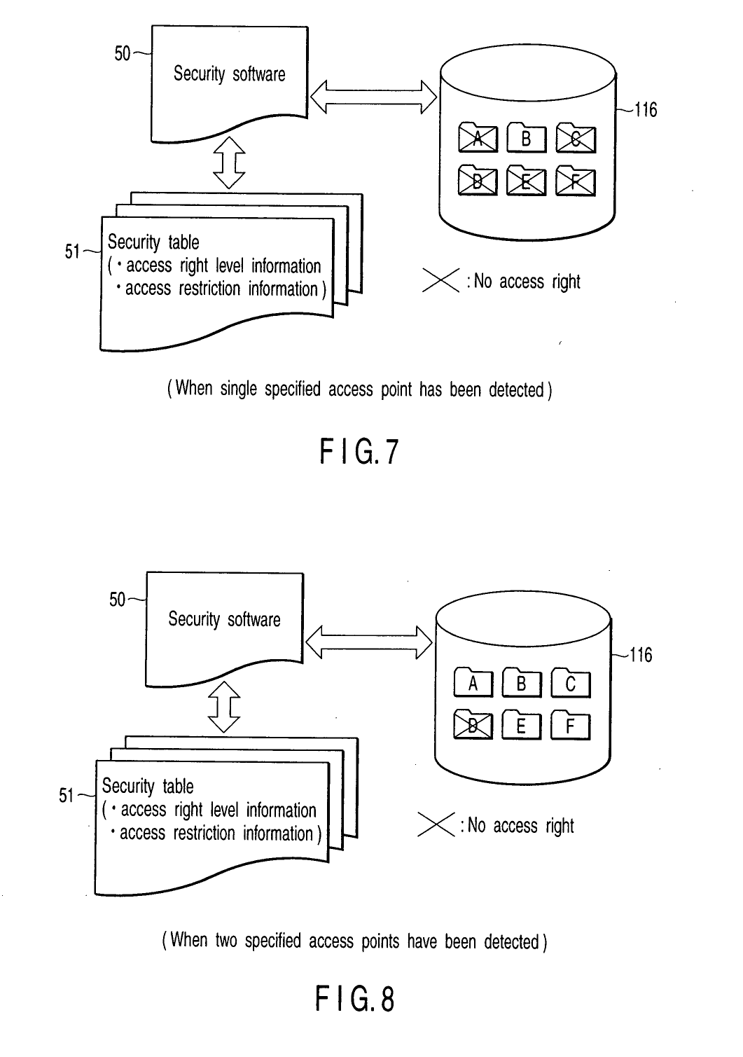

Next, referring to FIG. 7 to FIG. 9, examples of the access control process for access to data on the local disk are described.

FIG. 7 shows an example of the access control for access to files in a case where only one of three predetermined specified access points has been detected.

A security table 51 is a table which stores the above-described access right level information and access restriction information. The HDD 116 stores a file A, a file B, a file C, a file D, a file E and a file F. Assume now that an access right level 3is set for the file B, an access right level 2is set for the file A, file C, file E and file F, and an access right level 1is set for the file D. Information indicative of the relationship between the files and the access right levels is included in the access restriction information.

The security software 50 refers to the access right level information in the security table 51, and determines the access right level corresponding to the detected one specified access point. The determined access right level is, e.g., level 3. In this case, an accessible file is only the file B, and access to the other files A, C, D, E and F is prohibited.

FIG. 8 shows an example of the access control for access to files in a case where only two of three predetermined specified access points have been detected.

The security software 50 refers to the access right level information in the security table 51, and determines the access right level corresponding to the detected two specified access points. The determined access right level is, e.g., level 2. In this case, accessible files are the files A, B, C, E and F, and access to the file D is prohibited.

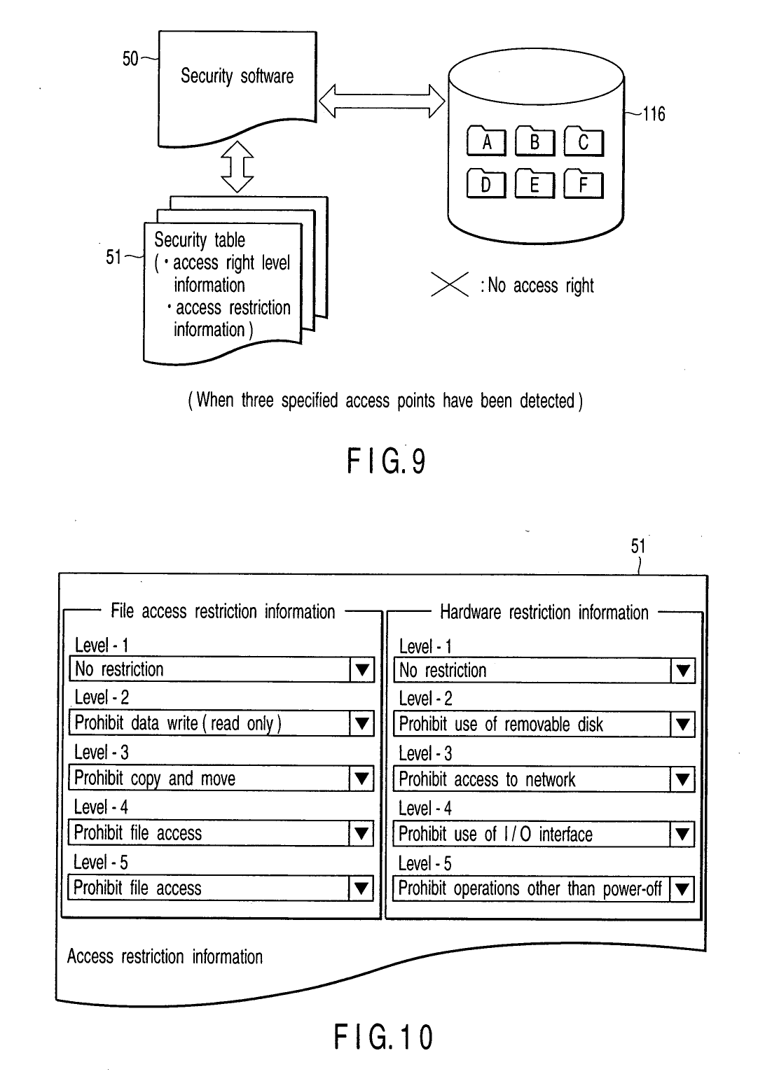

FIG. 9 shows an example of the access control for access to files in a case where all of the three predetermined specified access points have been detected.

The security software 50 refers to the access right level information in the security table 51, and determines the access right level corresponding to the detected three specified access points. The determined access right level is, e.g., level 1. In this case, all the files A, B, C, D, E and F can be accessed.

Instead of specifying the access right levels indicative of accessible files in association with the individual files, it is possible to specify the access right levels indicative of folders (or directories) in association with the individual folders (or directories).

FIG. 10 shows an example of a user interface for setting up access restriction information.

Assume now that the access restriction information includes file access restriction information and hardware restriction information. The file access restriction information specifies the relationship between access right levels Level-1 to Level-5, on the one hand, and the kinds of file operations to be restricted, on the other hand. An administrator can designate the kinds of file operations to be restricted, in association with the access right levels, by using, e.g., a pull-down menu which is displayed on the screen by security software 50.

In the setup example shown in FIG. 10, in Level-1, the kind of file operation, which is executable, is not restricted. In Level-2, the execution of data write is prohibited. In Level-3, copy and move of a file are prohibited. In Level-4 and Level-5, any kind of file access is prohibited.

The hardware restriction information specifies the relationship between access right levels Level-1 to Level-5, on the one hand, and hardware functions to be restricted, on the other hand. The administrator can designate the functions of hardware to be restricted, in association with the access right levels, by using, e.g., a pull-down menu which is displayed on the screen by security software 50.

In the setup example shown in FIG. 10, in Level-1, no hardware function is restricted. In Level-2, the access to a removable disk (e.g., memory card, USB memory), which is detachably attached to the computer main body, is prohibited. In Level-3, network access is prohibited. In Level-4, the use of an I/O interface is prohibited. In Level-5, the execution of all functions, except a power-off function, is prohibited.

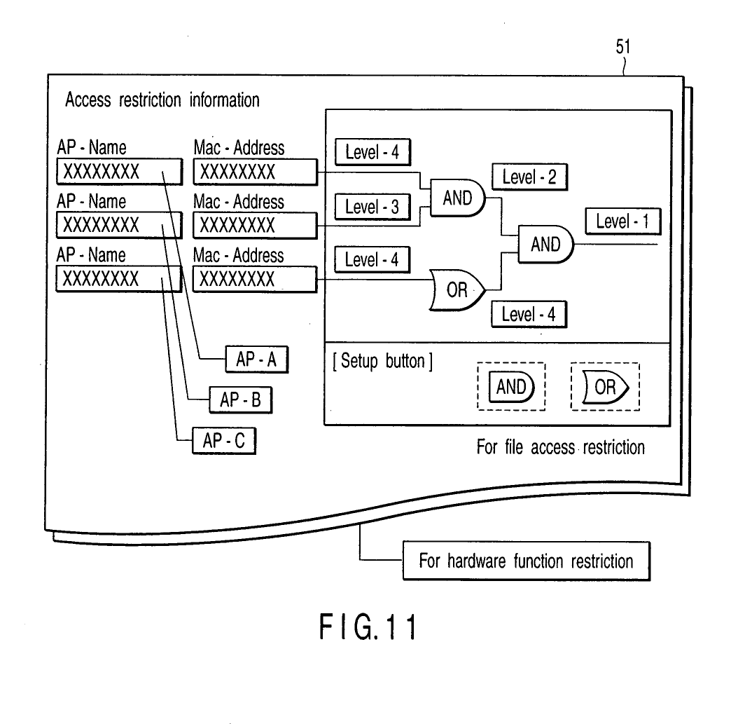

FIG. 11 shows an example of the user interface for setting up the access right level information.

The access restriction information specifies the relationship between the combinations of access points and the access right levels. The relationship between the combinations of access points and the access right levels can be individually specified for the file access restriction information and the hardware restriction information.

In FIG. 11, the access right levels are specified, as described below, by using some combinations of the three access points, i.e., access point A 100, access point B 101 and access point C 102.

An access right level in a case where only the access point A 100 has been detected is Level-4. An access right level in a case where only the access point B 101 has been detected is Level-3. An access right level in a case where only the access point C 102 has been detected is Level-4.

An access right level in a case where only the two access points A 100 and B 101 have been detected is Level-2. An access right level in a case where all of the three access points A 100, B 101 and C 102 have been detected is Level-1.

The administrator may arbitrarily use combinations of, e.g., setup buttons AND and OR, thereby to create arbitrary combinations of the three access points A 100, B 101 and C 102 and to designate access right levels in association with the respective combinations.

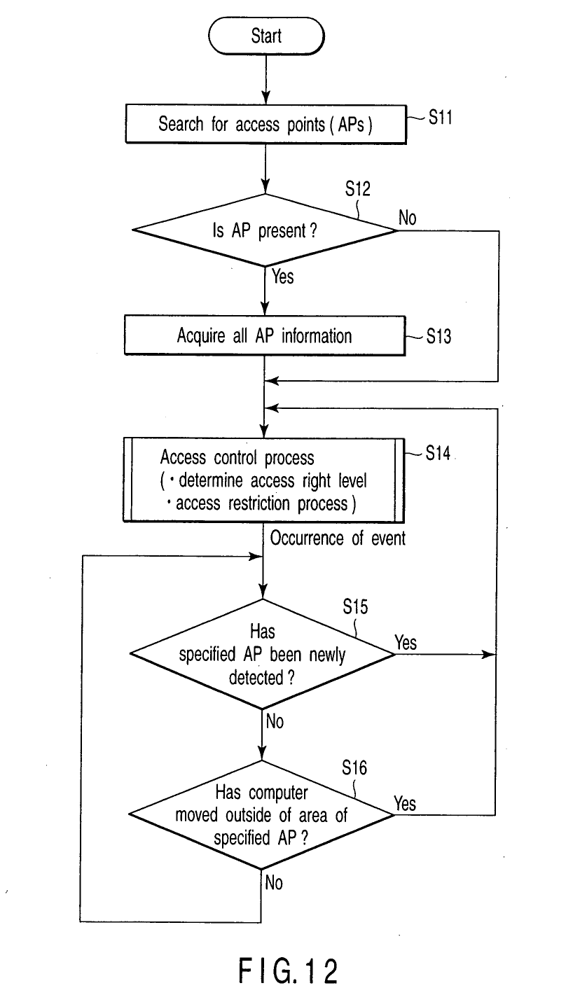

Next, referring to a flowchart of FIG. 12, the procedure of the process which is executed by the security software is described.

The CPU 111 executes the security software 50 and thereby executes the following process.

To start with, the CPU 111 controls the wireless communication unit 117 and executes the access point search process for detecting all access points which are wirelessly connectable to the wireless communication unit 117 (block S11). In the access point search process, the wireless communication unit 117 receives a beacon signal which is sent from each access point. The beacon signal includes access point information indicative of the ID of the access point. If the main body of the computer 201 is present within a communication area covered by a certain access point, the wireless communication unit 117 can acquire access point information indicative of the ID of this access point.

In the case where one or more access points, which are wirelessly connectable to the wireless communication unit 117, are present (YES in block S12), that is, if one or more access points have been detected by the access point search process, the CPU 111 acquires the ID of each of the detected access points as access point information (AP) (block S13). In accordance with the combination of the detected access points, the CPU 111 executes the access control process for the hardware functions of the computer 201 and for the data stored in the local disk of the computer 201 (block S14).

In block S14, the CPU 111 determines the access right level corresponding to the combination of the detected access points, and determines, in accordance with the determined access right level, the data which is to be access-restricted, the content of the file operation to be restricted, and the hardware function to be restricted. The access to confidential data is permitted in the case where all of a plurality of predetermined specified access points have been detected by the access point search process.

The access point search process can be periodically executed. In this case, the access control process in block S14 is executed each time the combination of access points detected by the access point search process is altered.

Specifically, if a new access point is detected, a device detection event is issued, for example, from the operating system to the security software. If the device detection event is issued, the CPU 111 executes a process of determining whether one of the specified access points has newly been detected (block S15) and a process of determining whether the already detected specified access point is no longer detected (i.e., whether the computer 201 has moved to the outside of the communication area of the already detected specified access point) (block S16).

In the case where one of the plural specified access points has newly been detected (YES in block S15) or the computer 201 has moved to the outside of the communication area of the already detected specified access point (YES in block S16), the CPU 111 executes the access control process of block S14 and redetermines the access right level once again. As described above, since the access control process is executed each time the combination of access points detected by the access point search process is altered, the access right level can dynamically be changed in accordance with the movement of the computer 201.

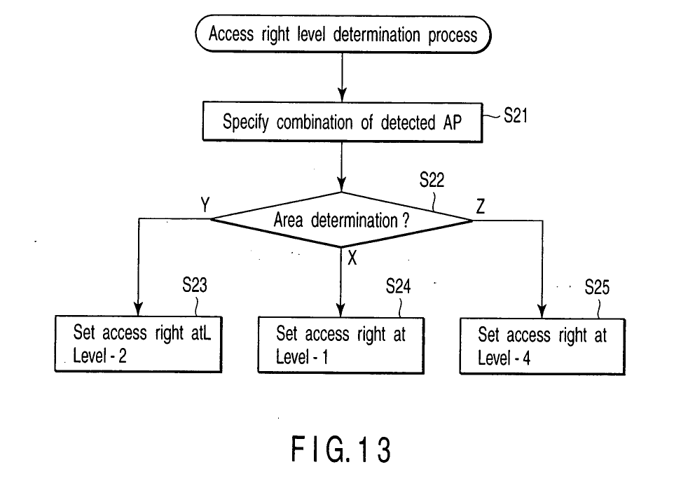

Next, referring to a flowchart of FIG. 13, the procedure of the process of determining the access right level is described. It is assumed that the access right level is determined according to in which of the areas X, Y and Z shown in FIG. 1 the computer 201 is present.

To start with, the CPU 111 specifies the combination of detected access points (block S21) and determines in which of the areas X, Y and Z shown in FIG. 1 the computer 201 is present, according to the specified combination (block S22).

If the specified combination is the combination of two access points 100 and 101, the CPU 111 determines that the computer 201 is present in the area Y and sets the access right level at, e.g., Level-2 (block S23). If the specified combination is the combination of three access points 100, 101 and 102, the CPU 111 determines that the computer 201 is present in the area X and sets the access right level at, e.g., Level-1 (block S24). If only one access point 102 is detected, the CPU 111 determines that the computer 201 is present in the area Z and sets the access right level at, e.g., Level-4 (block S25).

Actually, the access right level to be set can directly be determined from the combination of detected access points since the relationship between the combinations of access points and the access right levels is defined in the above-described access right information.

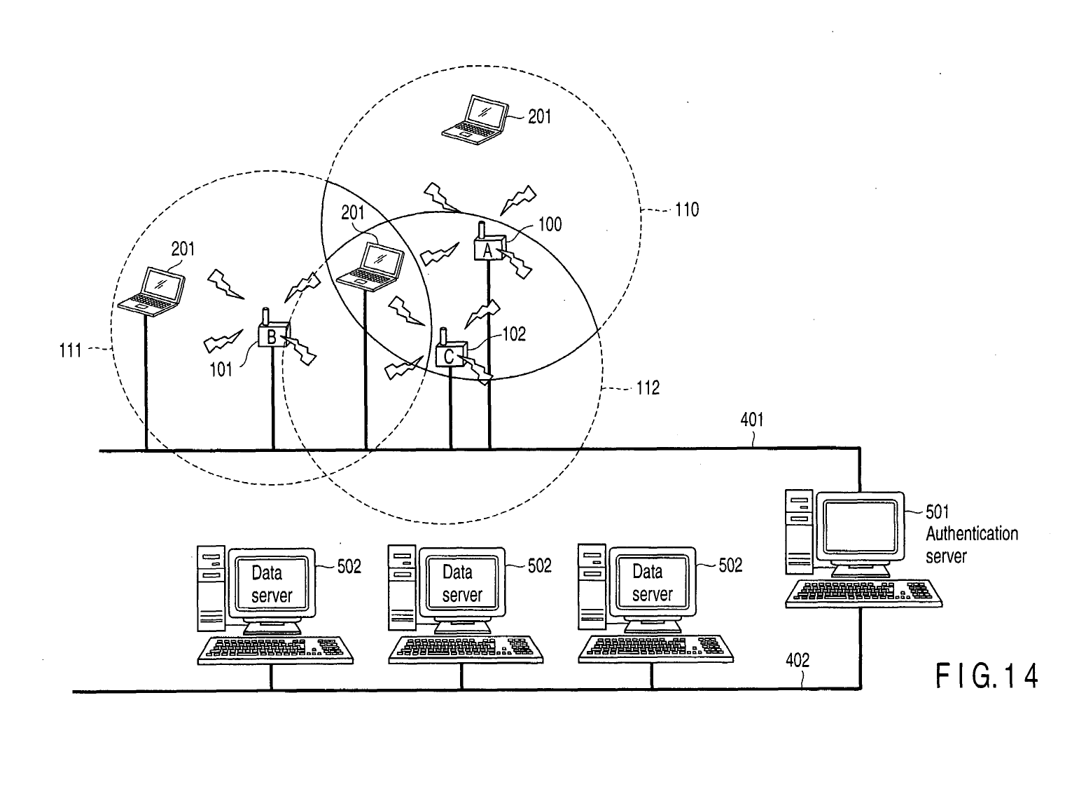

Next, referring to FIG. 14, a description is given of an example of the structure of a network system in which the computer 201 according to the present embodiment is used as a client computer.

Three access points 100, 101 and 102 are connected to a wired network 401 such as a wired LAN. The computer 201 is connected to the wired network 401 directly or via the access point.

In addition, a plurality of data server computers 502 are connected to a wired network 402 such as a wired LAN. The data server computers 502 store various data which is shared by client computers in the network system. An authentication server computer 501 is connected between the wired network 401 and wired network 402.

The authentication server 501 authenticates the computer 201 that functions as the client computer. Based on the authentication result, the authentication sever 501 permits the computer 201 to access, or prohibits the computer 201 from accessing, predetermined data stored in the data servers 502. In the authentication of the computer 201, detected-base-station information, which is sent from the computer 201, is used. The detected-base-station information is information indicative of combinations of base stations which have been detected by the computer 201.

As described above, in the network system shown in FIG. 14, the combination of base stations detected by the computer 201 is used for the access control for access to the data stored in the data server computers 502, in addition to the access control for access to the data stored in the local disk in the computer 201.

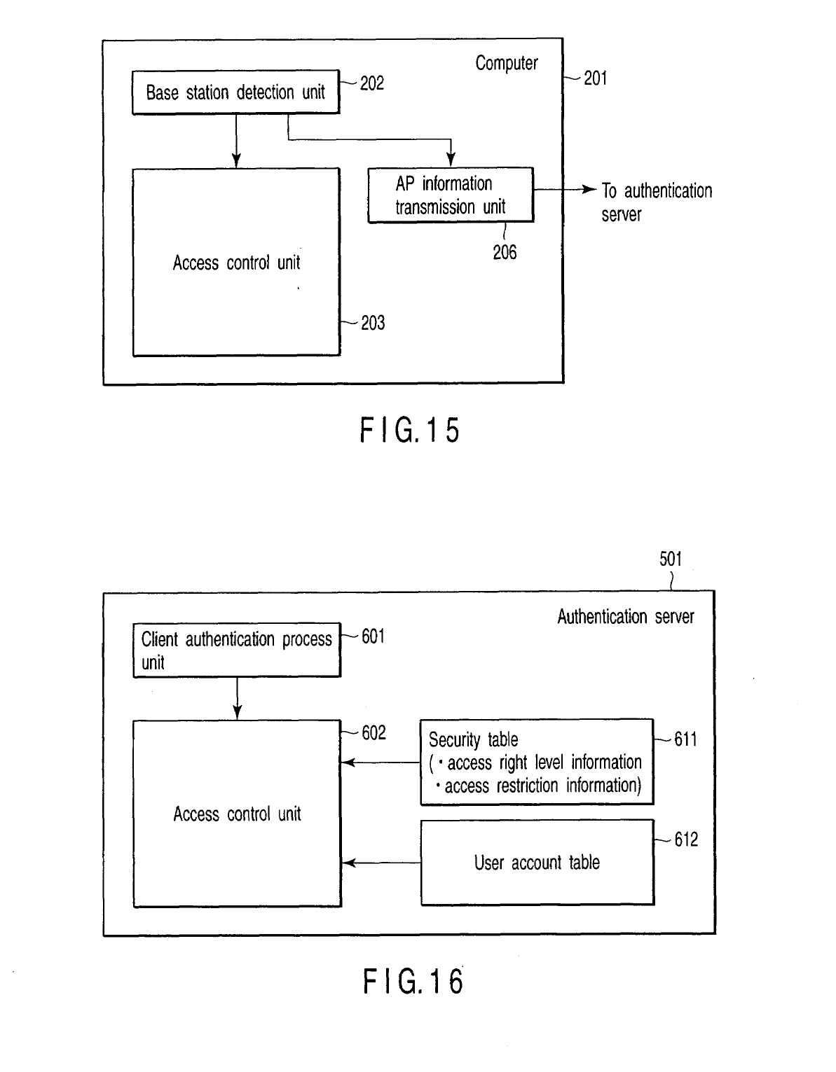

FIG. 15 shows the structure of the computer 201 functioning as the client computer. The computer 201 includes an access point information transmission unit 206 in addition to the above-described base station detection unit 202 and access control unit 203. The access point information transmission unit 206 transmits to the authentication server computer 501 over the wired network 401 the detected-base-station information which is indicative of the combination of access points detected by the access point search process that is executed by the base station detection unit 202.

FIG. 16 shows the structure of the authentication server computer 501.

The authentication server computer 501 includes a client authentication process unit 601, an access control unit 602, a security table 611 and a user account table 612.

The client authentication process unit 601 accesses each of base stations indicated by detected-base-station information sent from the computer 201 and confirms the presence of the computer 201, thereby verifying whether the detected-base-station information is valid or not. For example, in the case where the detected-base-station information indicates three access points 100, 101 and 102, the client authentication process unit 601 access the three access points 100, 101 and 102 and verifies whether the detected-base-station information is valid or not. If the computer 201 has been detected by each of the three access points 100, 101 and 102, the detected-base-station information is valid.

If the client authentication process unit 601 has verified that the detected-base-station information is valid, the access control unit 602 executes an access control process of determining whether or not to permit the computer 201 to access predetermined data such as confidential data stored in the data server computer 502, in accordance with the combination of the access points indicated by the detected-base-station information.

The access control unit 602 determines the access right level corresponding to the combination of the access points indicated by the detected-base-station information, in accordance with access right level information which is prestored in the security table 611. The access right level information is information which specifies the relationship between combinations of access points, on the one hand, and access right levels, on the other hand. In the access right level information, for example, the access right level corresponding to the combination of three access points, i.e., access point A 100, access point B 101 and access point C 102, is set at level 1. The access right level corresponding to the combination of two access points, i.e., access point A 100 and access point B 101, is set at level 2. The access right level corresponding to each of the access point A 100, access point B 101 and access point C 102, is set at level 3.

The access control unit 602 determines whether or not to permit access to predetermined data such as confidential data, which is stored in the data server computer 502, in accordance with the determined access right level.

In the meantime, the kind of a file operation which is executable on predetermined data may be restricted in accordance with the determined access right level.

In this case, the access control unit 602 restricts the kind of a file operation (read access, write access, copy, move, etc.) which is executable on predetermined data such as confidential data, on the basis of the determined access right level and access restriction information which is prestored in the security table 611. The access restriction information is information which specifies the relationship between a plurality of access right levels, on the one hand, and the kinds of file operations to be restricted, on the other hand.

Actually, not only the access right levels but also the user account of the user of the computer 201 is used in the access control process. When the computer 201 logs in to the network system, the client authentication unit 601 authenticates the user account (administrator, power user, user, or guest) of the user of the computer 201 by referring to the user account table 612.

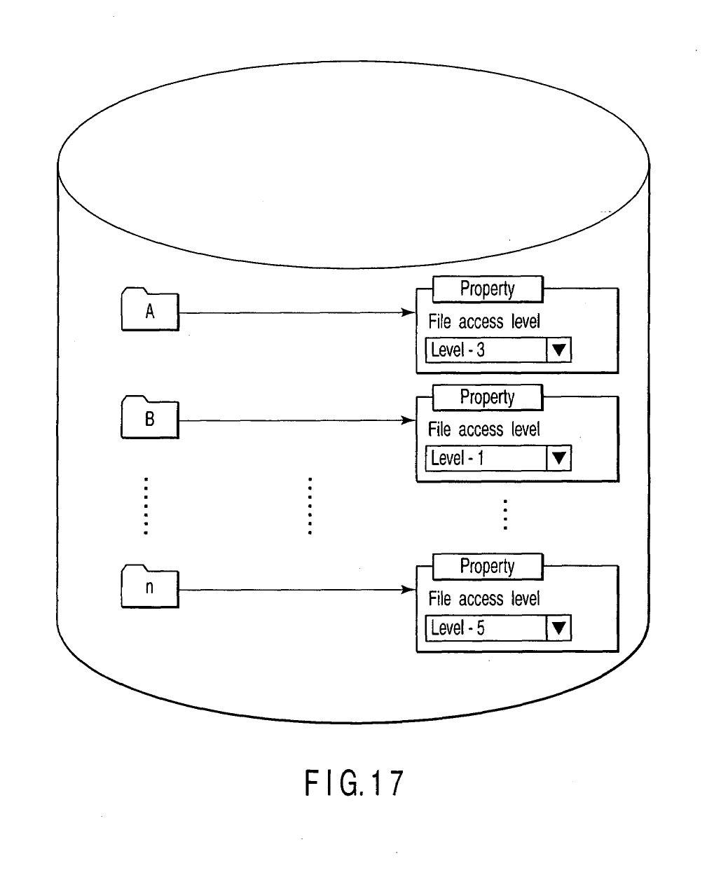

As is shown in FIG. 17, the administrator of the network system is able to set, in association with each of files stored in the data server computer 502, the access right level (file access level) which is necessary for accessing the file. In the example shown in FIG. 17, the access right level of a file A is set at Level-3, the access right level of a file B is set at Level-1, and the access right level of a file n is set at Level-5.

In this case, the access to the file B by the computer 201 is permitted only when the computer 201 is present within the area X. If the user account of the user of the computer 201 disagrees with the user account for which the access to the file B is permitted, the access to the file B by the computer 201 is prohibited even if the computer 201 is present within the area X.

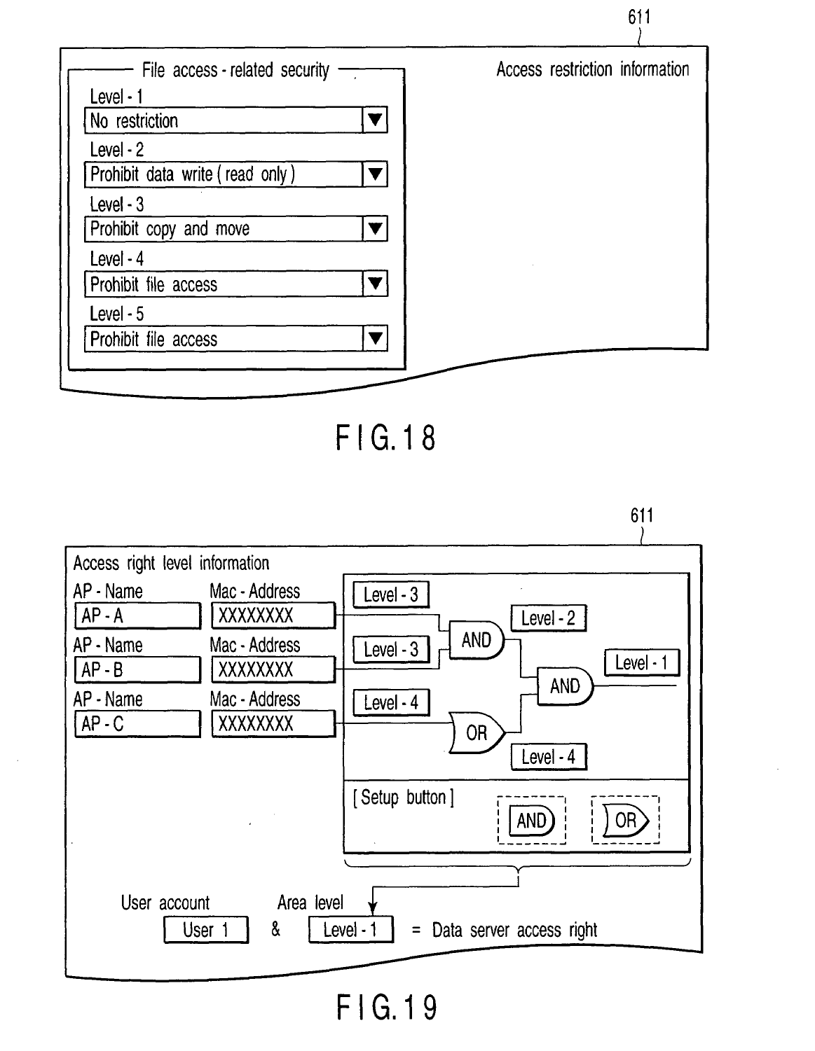

FIG. 18 shows an example of the user interface for setting up access restriction information which is to be stored in the security table 611.

The access restriction information specifies the relationship between access right levels Level-1 to Level-5, on the one hand, and the kinds of file operations to be restricted, on the other hand. The administrator can designate the kinds of file operations to be restricted, in association with the individual access right levels.

FIG. 19 shows an example of the user interface for setting up access right level information which is to be stored in the security table 611.

The access restriction information specifies the relationship between the combinations of access points and the access right levels. The administrator may arbitrarily use combinations of, e.g., setup buttons AND and OR, thereby to create arbitrary combinations of the three access points A 100, B 101 and C 102 and to designate access right levels in association with the respective combinations.

The access right level indicates the safety level of the area in which the computer 201 is present. In this sense, the access right level may be referred to as “area level”. The access right to the data on the data server computer 502 can be determined by the combination of the access right level (area level) and the user account.

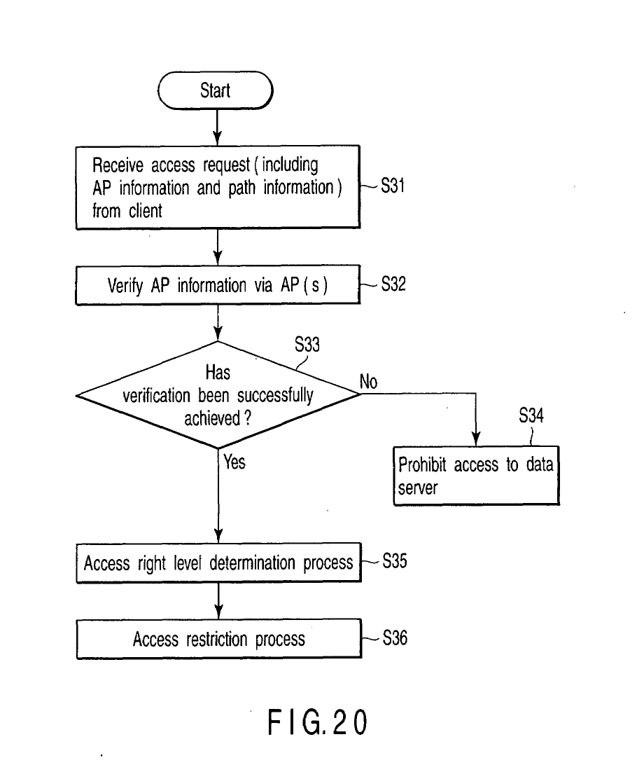

Next, referring to a flowchart of FIG. 20, the procedure of the process which is executed by the authentication server computer 501 is described.

The authentication server computer 501 receives an access request which is sent from the computer 201 over the wired network 401 (block S31). The access request includes the above-described detected-base-station information and path information indicative of a file to be accessed.

The authentication server computer 501 accesses the access points which are indicated by the detected-base-station information, and verifies whether the detected-base-station information is valid or not (block S32).

If the detected-base-station information is invalid (NO in block S33), the authentication server computer 501 sends an error message to the computer 201 and prohibits the computer 201 from accessing the data server computer 502 (block S34).

If the detected-base-station information is valid (YES in block S33), the authentication server computer 501 determines the access right level corresponding to the combination indicated by the detected-base-station information (block S35) and determines, in accordance with the access right level, whether or not to permit the access to the file that is designated by the path information (block S36).

As has been described above, according to the present embodiment, the use of data, such as confidential information, can be permitted only in the case where the place of use of the computer 201 is within a secure area.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a wireless communication unit;
a storage device which stores predetermined data;
a detection unit which detects base stations which are wirelessly connectable to the wireless communication unit; and
an access control unit which determines whether or not to permit access to the predetermined data, in accordance with a combination of the base stations which are detected by the detection unit.

2. The information processing apparatus according to claim 1, wherein the access control unit permits the access to the predetermined data if a plurality of specified base stations are detected by the detection unit, and prohibits the access to the predetermined data if at least one of the plurality of specified base stations is not detected.

3. The information processing apparatus according to claim 1, wherein the access control unit determines an access right level, which corresponds to the combination of base stations detected by the detection unit, on the basis of access right level information which specifies a relationship between combinations of base stations, on the one hand, and access right levels, on the other hand, and determines whether or not to permit the access to the predetermined data, in accordance with the determined access right level.

4. The information processing apparatus according to claim 1, wherein the predetermined data is stored in the storage device as a file,
the information processing apparatus further comprises a memory unit which stores access restriction information which specifies a relationship between a plurality of access right levels, on the one hand, and kinds of file operations to be restricted, on the other hand, and access right level information which specifies a relationship between combinations of base stations, on the one hand, and the plurality of access right levels, on the other hand, and
the access control unit includes means for determining, on the basis of the access right level information, the access right level which corresponds to the combination of base stations detected by the detection unit, and means for restricting the file operation which is executable on the predetermined data, on the basis of the access restriction information and the determined access right level.

5. The information processing apparatus according to claim 1, wherein the access control unit determines whether or not to permit the access to the predetermined data, each time the combination of base stations detected by the detection unit is varied.

6. The information processing apparatus according to claim 1, further comprising a transmission unit which transmits detected-base-station information, which is indicative of the combination of base stations detected by the detection unit, to an authentication server computer over a network, and
the authentication server computer accesses the base stations indicated by the detected-base-station information thereby to verify whether the detected-base-station information is valid or not, and determines, if it is verified that the detected-base-station information is valid, whether or not to permit the information processing apparatus to access predetermined data stored in a data server computer, in accordance with the combination of base stations indicated by the detected-base-station information.

7. The information processing apparatus according to claim 6, wherein the authentication server computer determines whether or not to permit the information processing apparatus to access the predetermined data stored in the data server computer, in accordance with a user account of a user of the information processing apparatus and the combination of base stations indicated by the detected-base-station information.

8. An access control method for restricting data which is accessible by an information processing apparatus which executes wireless communication, comprising:
executing a process of detecting base stations which are wirelessly connectable to the information processing apparatus; and
executing an access control process of determining, in accordance with a combination of the detected base stations, whether or not to permit access to predetermined data which is stored in a data storage device provided in the information processing apparatus.

9. The access control method according to claim 8, wherein the access control process permits the access to the predetermined data if a plurality of specified base stations are detected by the detection process, and prohibits the access to the predetermined data if at least one of the plurality of specified base stations is not detected.

10. The access control method according to claim 8, wherein the access control process determines an access right level, which corresponds to the combination of the detected base stations, on the basis of access right level information which specifies a relationship between combinations of base stations, on the one hand, and access right levels, on the other hand, and determines whether or not to permit the access to the predetermined data, in accordance with the determined access right level.

11. The access control method according to claim 8, wherein the predetermined data is stored in the storage device as a file,
a memory unit provided in the information processing apparatus stores access restriction information which specifies a relationship between a plurality of access right levels, on the one hand, and kinds of file operations to be restricted, on the other hand, and access right level information which specifies a relationship between combinations of base stations, on the one hand, and the plurality of access right levels, on the other hand, and
the access control process includes a process of determining, on the basis of the access right level information, the access right level which corresponds to the combination of the detected base stations, and a process of restricting the file operation which is executable on the predetermined data, on the basis of the access restriction information and the determined access right level.

12. The access control method according to claim 8, wherein the access control process determines whether or not to permit the access to the predetermined data, each time the combination of the detected base stations is varied.

13. The access control method according to claim 8, further comprising transmitting detected-base-station information, which is indicative of the combination of the detected base stations, to an authentication server computer over a network, and
the authentication server computer accesses the base stations indicated by the detected-base-station information thereby to verify whether the detected-base-station information is valid or not, and determines, if it is verified that the detected-base-station information is valid, whether or not to permit the information processing apparatus to access predetermined data stored in a data server computer, in accordance with the combination of base stations indicated by the detected-base-station information.

14. The access control method according to claim 13, wherein the authentication server computer determines whether or not to permit the information processing apparatus to access the predetermined data stored in the data server computer, in accordance with a user account of a user of the information processing apparatus and the combination of base stations indicated by the detected-base-station information.
